(19) United States
(12) Patent Application Publication
(10) Pub. No.: US 2025/0346130 A1
(43) Pub. Date: Nov. 13, 2025

(54) ON-BOARD CHARGING INTERFACE

(71) Applicant: Deere & Company, Moline, IL (US)

(72) Inventor: Amy K. JONES, Asbury, IA (US)

(73) Assignee: Deere & Company, Moline, IL (US)

(21) Appl. No.: 18/656,756

(22) Filed: May 7, 2024

(51) Int. Cl. B60L 53/14; B60L 53/30; B60L 58/12

(52) U.S. Cl. CPC B60L 53/14; B60L 53/305; B60L 58/12; B60L 2250/16

(57) ABSTRACT

An on-board charge management system and technique extends a mapping platform with charging-related features. A map of an environment may be displayed on an operator display of an electric machine. The map may indicate one or more chargers deployed in the area. Selection of a charger may initiate actions such as reserving the charger, targeting the charger, or the like. The electric machine monitors a state of charge and notifies an operator when to travel to a charger.

### BACKGROUND

Given changing economic, environmental, and performance metrics, electric machines are increasing in popularity. Electric machines are finding applications in transportation, agricultural, construction, and industrial settings. Supporting electric machines in an environment is different compared to conventional machines reliant on fossil fuels.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one implementation, an electric machine is provided. The electric machine includes a battery assembly, an operator interface, and a controller that receives input data indicative of a battery assembly state and charger information. The controller includes at least one processor and a memory that stores instructions that, when executed by the at least one processor, configure the at least one processor to: generate display information based on the battery assembly state and charger information; output the display information on the operator interface, wherein the operator interface displays a user interface having a first portion providing area information; receive a user input via the operator interface, wherein the user input is indicative of a selection of an object in an area corresponding to the area information; and execute an operation based on the user input, wherein the operation relates to charging of the battery assembly.

In another implementation, a system for managing charging of electric machines is provided. The system includes an electric machine and a charger. The electric machine includes a display assembly. The display assembly includes a display screen with a touch interface, a memory, and a processor coupled to the memory. The processor is configured to receive charger information, the charger information including at least a location, a capacity, and an availability of the charger. The processor is further configured to output a touch-enabled user interface to the display screen. The user interface includes a map of an environment in which the electric machine is deployed. The map indicates at least a location of the electric machine and a location of the charger. The processor is further configured to receive a user input via the display screen indicative of a selection of the charger. In addition, the processor is configured to initiate automatic procedures related to charging in response to the selection of the charger.

In yet another implementation, a method for managing charging on-board an electric machine is provided. The method includes receiving a state of charge of the electric machine. The method also includes receiving charger information respectively associated with one or more chargers deployed in an area. In addition, the method includes displaying a user interface on an operator display of the electric machine. The user interface includes a first portion providing information related to the state of charge and a second portion providing a map of the area. The map indicates the electric machine and the one or more chargers. The method further includes receiving, via the operator display, user input indicative of a selection of a charger from the one or more chargers displayed on the map. Also, the method includes, responsive to the selection of the charger, autonomously carrying out a charging-related operation based on charger information associated with the charger selected and the state of charge of the electric machine.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

Various non-limiting embodiments are further described in the detailed description given below with reference the accompanying drawings, which are incorporated in and constitute a part of the specification.

FIG. 1 illustrates a schematic diagram of an exemplary, non-limiting implementation of a charging management system according to various aspects.

FIG. 2 illustrates a block diagram of an exemplary, non-limiting implementation of a computing device configured to manage charging for an electric machine according to various aspects.

FIG. 3 illustrates a schematic diagram of an exemplary, non-limiting implementation for a user interface in accordance with various aspects.

FIG. 4 illustrates a schematic diagram of an exemplary, non-limiting implementation of a charging management system according to various aspects.

FIG. 5 illustrates a flow chart of an exemplary, non-limiting implementation for managing charging for an electric machine according to various aspects.

FIG. 6 is a schematic diagram of an exemplary, non-limiting implementation of a computing device according to various aspects.

### DETAILED DESCRIPTION

As described above, electric machines change logistical support operations. For battery electric machines, for example, logistical support operations include charging management. In some application with battery electric machines (and battery electric vehicles, in particular), utilization rates are very high. Accordingly, downtime can be costly.

Compared to refueling of conventional machines and vehicles, charging electric machines and vehicles presents different challenges. For instance, with a plurality of vehicles deployed in an environment (e.g. agricultural fields, construction worksites, etc.), provisioning, scheduling, management, and control of charging devices are managed. Further, orchestration of the machines and vehicles to optimize charging presents further logistical challenges. From a perspective of an operator, logistical information and management associated with charging can be a burden even when reduced to a single machine.

A charging management system and techniques are described herein. The system acquires logistical information related to charging and provides an on-board charging interface to an operator of the machine. The on-board charging interface facilitates management of charging-related operations, which may be executed by the system in an automated or semi-automated manner.

In an aspect, the on-board charging interface includes a mapping platform integrated with charging-related features. The on-boarding charging interface may also provide machine information such as a state of charge. The map of the on-board charging interface may indicate locations of chargers in an area.

In a further example, on-board charging interface may be displayed on an operator display, which may be implemented by a productivity display. The productivity display, in an example, may be a touchscreen display on the machine. Accordingly, in some examples, user input may be provided via touch.

User input received via the on-board charging interface (whether touch-based or otherwise) may be indicative of a selection of a charger shown within an environment or area corresponding to a displayed map. In one example, the selection of a charger may be indicative of a request for the charger. For instance, the charger may be a mobile charger and the request may be a request for the mobile charger to traverse to the electric machine. In another example, the selection of a charger may be indicative of a request to reserve the charger. The reservation may be for a particular timeslot, may indicate a need for a charger after a particular amount of time, and/or may be a request to be scheduled for the charger. In another aspect, the selection of a charger may be indicative of a targeting of the charger. In one example, a traversal distance between the electric machine and the targeted charger is monitored along with a state of the charge of the machine. The operator is notified when the machine needs to commence travel to the charger. In the case of a mobile charger, the mobile charger may be notified to travel to the electric machine at the appropriate time. Based on timing, the electric machine may initiate preconditioning of a battery for charging.

In a further aspect, the operation of the electric machine can be monitored. For example, the utilization of the machine is monitored such as what workloads are being performed and the manner in which the machine is being used by the operator. Based on these inputs, battery life predictions can be determined. The battery life predictions can be utilized to automatically generate notifications to leave for charging, or commands to mobile chargers to travel to the machine.

In another example, a remote system such as an operations management system can drive the mapping platform for the on-board charging interface. The operations management system can provide map information and asset information to the machine for integration within the on-board charging interface. The asset information may include charger information acquired from one or more chargers deployed in an area. The chargers may be tagged or identified via the operations management system to make the charger information available to the machines. In a further example, the operations management system can monitor machine status and charger information, and execute charging-related operations accordingly. For example, the operations management system can notify an operator, via the on-board charging interface for instance, when a state of charge reaches a predetermined limit. The limit may be based on a travel time to a charger plus a margin. The operations management system may also notify a mobile charger to travel to a machine.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

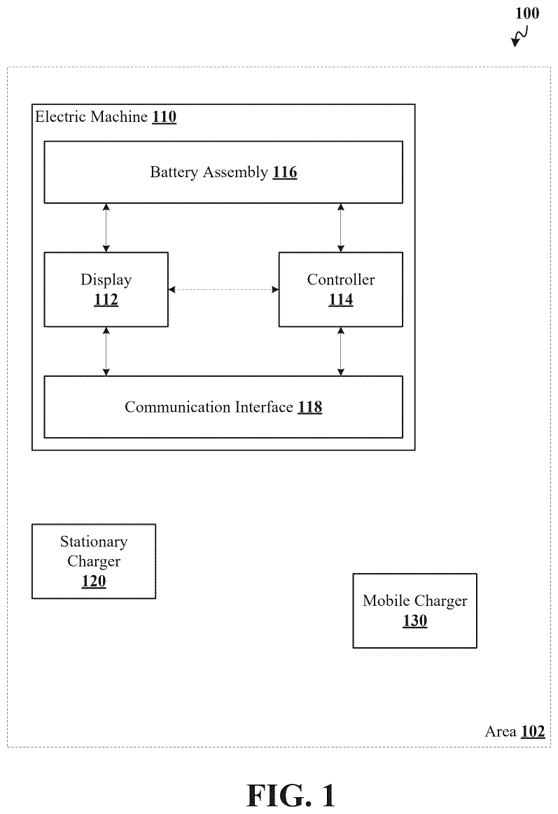

Referring initially to FIG. 1, an exemplary, non-limiting implementation of a charging management system 100 is illustrated. As shown in FIG. 1, system 100 may be utilized in an area 102. According to various examples, area 102 may be a jobsite (e.g. a construction worksite), an agricultural environment (e.g. agricultural fields and associated environment), or any other area in which electric machines are utilized.

System 100 may be utilized with an electric machine 110. As with the various examples of environments, system 100 may be utilized with a wide array of electric machines. For example, electric machine 110 may be, but is not limited to, a construction machine or vehicle, an agricultural machine or vehicle, an industrial machine or vehicle, or the like. As shown in FIG. 1, in some implementations, electric machine 110 may include a battery assembly 116 having one or more batteries configured to supply electrical power to components of the electric machine 110 to enable the machine to carry out various operations or workloads. Electric machine 110 further includes a controller 114, which may be a computer processor, a computing device, an electronic control unit, a system-on-a-chip (SOC), a microcontroller or the like. The controller 114 can control operation of the electric machine 110, monitor components of the electric machine 110, and/or perform data processing to enable operation of system 100 and/or electric machine 110. Further, electric machine 110 may include a display 112. Display 112 may be an operator display, or a productivity display, mounted on electric machine 110. For instance, display 112 may be an in-cab display. According to various aspect, display 112 may output or display an operator or user interface to enable interaction between an operator and the electric machine 110. In some implementations, display 112 may be a touch-based display. According to further examples, display 112 may be a computing device. That is, display 112 may include a memory, a processor, peripherals (e.g. graphics processing unit, etc.).

Electric machine 110, as shown in FIG. 1, may include a communications interface 118. In an aspect, communications 118 may be a wired or wireless communications interface to communicatively couple electric machine 110 with other computing devices in area 102, remote computing devices (e.g. operations management system), and/or chargers 120, 130. Communications interface 118 can be coupled to and/or integrated with display 112 and/or controller 114. Via communications interface 118, electric machine 110 can receive and transmit information. Such information may include machine information, charger information, map information, etc. as described herein. In one implementation, communications interface 118 may be a modular telematic gateway (MTG), which is a telematic device (e.g. a computing device) having a wireless communications modem for communication via a wireless communications network (e.g. a cellular network).

According to an aspect of the charging management system 100, area 102 may include one or more chargers such as stationary charger 120 and mobile charger 130. Stationary charger 120 may be a charging station provisioned at a fixed point in area 102. Stationary charger 120 may be coupled to line power. Machine 110 would travel to stationary charger 120 and couple thereto to charge. Mobile charger 130 may be a charging station mounted on a vehicle or cart. Thus, mobile charger 130 may travel around area 102. Mobile charger 130 may include a generator or a large capacity battery assembly. In other implementations, mobile charger 130 may be another electric machine or another vehicle.

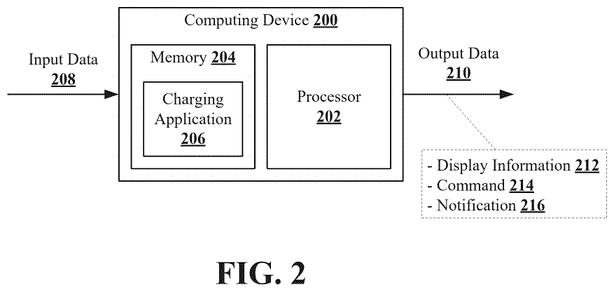

Turning to FIG. 2, an exemplary, non-limiting implementation of a computing device 200 configured to manage charging for an electric machine is illustrated. In an aspect, display 112 and/or controller 114 of FIG. 1 may be implemented in part by computing device 200. As shown in FIG. 2, computing device 200 receives input data 208 and outputs output data 210. Input data 212 may include various inputs as described above such as charger information, machine information (e.g. state of charge, machine workload, machine configuration), area information (e.g. map information), etc. In addition, input data 208 may include user input received via a user interface. Output data 210 may include information such as display information 212 (e.g. graphical user interface or other information displayed for an operator), a command 214 or request to another device (e.g. charger, remote system, etc.), and/or a notification 216 to an operator.

Computing device 200 includes a processor 202 configured to process data and instructions, and provide resulting data based on the processed data and instructions. The computing device 200 further includes a memory 204 (e.g., computer memory, such as a device or system that is used to store information for use in a computer or related computer hardware and digital electronic devices, including short and long-term memory, temporary and permanent memory, and the like). Memory 204 stores executable instructions for charging application 206. Charging application 206, when executed by processor 202, acquires input data 208 and generates output data 210, operates a graphical user interface (e.g. on-board charging interface), processes user input, and executes actions according to user input and/or trigger events.

Actions executed according to input data and/or trigger events may be notifications as noted above, commands or requests to other machines, or commands to the electric machine itself. Such actions may be autonomously executed. For instance, based on a state of charge (indicated in input data 212), power saving adaptations for the electric machine may be autonomously initiated to conserve battery power. Such adaptations may enable the electric machine to transit to a charging device. Further, charging application 206 may recommend actions to the operator or notify the operator of the power saving adaptations and need to charge. Recommended actions may be a recommended selection of a charging device to utilize, a recommendation to commence travel to a particular location, a recommendation to maintain a reduced speed, a recommendation to discontinue a particular activity, or the like.

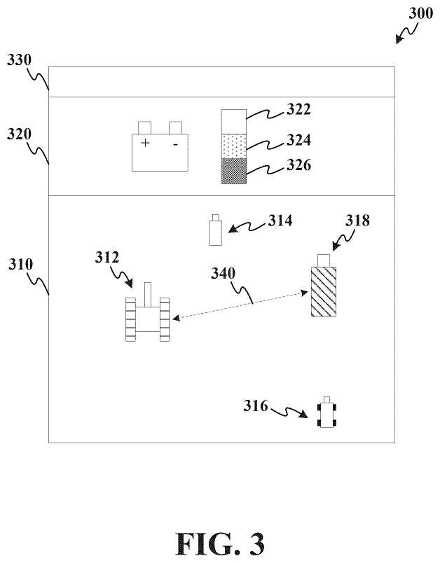

FIG. 3 illustrates a schematic diagram of an exemplary, non-limiting implementation of a user interface 300. The user interface 300 may be an on-board charging management interface on display 112 of electric machine 110 of FIG. 1. As shown in FIG. 3, user interface 300 may include several segmented portions or divisions in which different information is presented. In a first portion 310, area information is displayed. The area information may include a map of an area (such as area 102 for example). The map may indicate a location of an electric machine 312 where the user interface 300 is displayed, for example. Electric machine 312, in some implementations, may be electric machine 110 described above in FIG. 1. The map shown in the first portion 310 may also include one or more objects in the area. The one or more objects, in some implementations, may be charging devices. The charging devices may include stationary chargers 314 and 318. The area may also include mobile chargers, such as charger 316, which are additionally shown on the map. As shown in FIG. 3, the map conveys locations of chargers 314, 316, and 318 in the area and a relative placement of the chargers with respect to electric machine 312.

In a second portion 320 of the user interface 300, battery information may be depicted in some implementations. The battery information may convey a state of charge. In one implementation, a meter may be displayed. The meter may be a bar-type display whereby a full bar indicates a fully charged battery and an empty bar indicates a fully discharged battery. Positions in between indicate an amount of charge remaining in the battery. The meter may have multiple segments 322, 324, 326. The segments may be indicative of thresholds whereby a displayed color of the bar may change to indicate a status of the battery. For instance, when the bar is within segment 322, indicating an amount of charge above a first threshold, the bar may be green. When the bar is within segment 324, indicating the amount of charge is below the first threshold and above a second threshold, the bar may be yellow. When the bar is within segment 326, indicating the amount of charge is below the second threshold, the bar may be red. It is to be appreciated that the battery information in second portion 320 may be conveyed via different techniques. For example, the battery information may be displayed as a percentage value indicating a state of charge. In another example, the battery information may be an estimated time of remaining power. Still further, the battery information may include a combination of one or more of the aforementioned structures (e.g. a percentage with the bar; percentage, bar, and time; etc.).

User interface 300, in an implementation, is displayed on a touch screen. A charger may be tapped thereby selecting the charger. For example, charger 318 is shown as selected in FIG. 3. A selection of a charger may cause display of associated charger information (not shown in FIG. 3). According to an example, charger information may include a location of the charger, a charging capacity of the charger, an availability of the charger, a charger type (e.g. stationary or mobile), or the like. The charger information may also indicate a schedule for the charger. For example, the schedule may include timeslots and indicate whether a particular timeslot is available or filled.

A selection of a charger, such as charger 318, may initiate an action. In one example, the action may be a reservation action. With a reservation action, charger 318 is reserved for use by electric machine 312. For example, an available timeslot may be automatically assigned to electric machine 312 or a timeslot may be selected by the operator. According to another example, the action may be a targeting operation. The targeting operation identifies the selected charger (e.g. charger 318) as a targeted charger. The electric machine 312 (or remote system) monitors a state of charge and determines a time-to-travel between the electric machine 312 and the targeted charger 318. The time-to-travel can be monitored and updated, as necessary, due to movement of the charger 318 and/or electric machine 312. The operator of the electric machine 312 may be notified when a state of charge reaches a level that, when compared to the time-to-travel, indicates that the electric machine 312 should begin traveling to the charger 318. A route 340 may be displayed to the charger 318. Still further, the action may be a request action. The request action may be a request to use the charger 318. In the case of a mobile charger, the request action may be a command to the mobile charger to travel to the electric machine.

User interface 300 may further include a third portion 330. The third portion may display charger information, machine information, or other information. For instance, the third portion may display a scheduled timeslot with a charger for the electric machine. In another example, the third portion may display a time or distance to a charger. It to be appreciated that other operator selectable information may be displayed on third portion 330.

Notifications may be generated according to various techniques. For example, one technique to determine when to notify the operator may be based on a time-to-travel. According to another technique, notifications may be generated based on a power level or battery state of charge. For example, previous warnings or alerts may be ignored by an operator. Thus, when a power level or battery state of charge reduces to a predetermined threshold, a notification to head to a charger or bring a charger to the electric machine is triggered. According to this technique, the notification is triggered based on only the power level or battery state of charge.

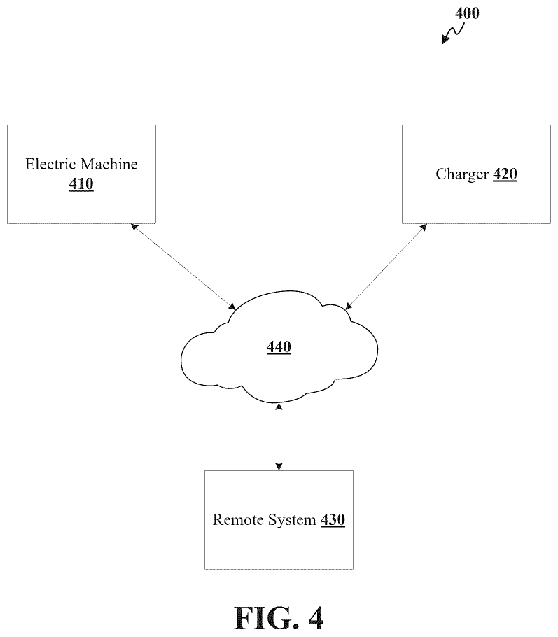

Turning to FIG. 4, a schematic diagram of an exemplary, non-limiting implementation of a charging management system 400 is illustrated. System 400 may be one implementation of system 100. As shown in FIG. 4, electric machine 410, charger 420, and a remote system 420 may be communicatively coupled via a network 440. Network 440 may be the Internet, a wireless network, a mesh network, or the like. Remote system 420 may be an operations management system, in some implementations. In other examples, remote system 420 may be a mobile computer device or other computing device utilized by the operator.

In one example, the remote system 430 can acquire machine information from electric machine 410 and charger information from charger 420. Based on the acquired information, the remote system 430 can carry out the functionality described above with respect to FIGS. 1 and 2. For instance, the remote system 430 can generate the output data (e.g. display information, etc.). In another example, the remote system 430 can acquire the charger information from charger 420 and communicate the charger information to the electric machine 410 for on-board charge management. As noted above, remote system 430 may be an operations management system. Accordingly, remote system 430 can acquire charger information from a plurality of chargers and tag those chargers for inclusion in area information sent to electric machine 410 to support the mapping platform.

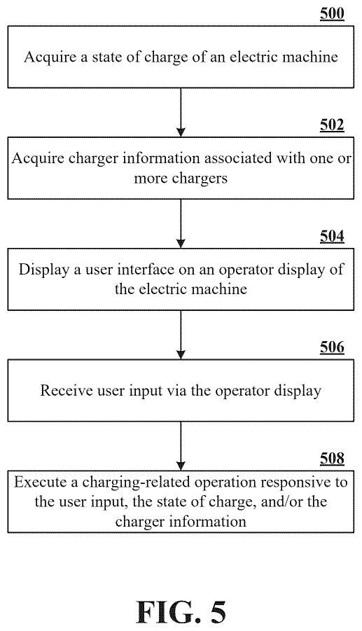

Turning to FIG. 5, various features and operations of the systems and techniques described herein are illustrated with an exemplary flowchart. The example in this figure is illustrative of some features of system 100, system 200, user interface 300, and/or system 400, but are not exhaustive. FIG. 5 illustrates a flowchart of a method for managing charging for an electric machine. The method of FIG. 5, in some implementations, may be performed by system 100, system 200, user interface 300, electric machine 110, remote system 430, and/or other computing device or controller associated with or in communication with electric machine 110.

The method can begin at 500 a state of charge of an electric machine is acquired. The state of charge may be acquired by a computing device (e.g. display 112, controller 114, computing device 200, etc.) on the electric machine polling a battery. Acquiring the state of charge may also include communicating the state of charge to another computing device. For example, the electric machine may poll the battery and transmit the state of charge to an operations management system, a mobile computing device of an operator, etc. In other examples, the state of charge is acquired by an on-board computing device.

At 502, charger information associated with one or more chargers is acquired. Charger information may be acquired by the electric machine by, for example, downloading the information from an operations management system. In other implementations, the electric machine may discover chargers in an environment (via peer-to-peer discovery, for example) and retrieve charger information directly. The charger information may include a location of a charger, a typer of a charger, an availability of a charger, a capacity of a charger, etc.

At 504, a user interface is displayed on an operator display of the electric machine. The user interface may include a map with charge-related functionality. In an example, the user interface displayed at 504 may be similar to user interface 300 of FIG. 3. At 506, user input is received via the operator display. At 508, a charging-related operation is executed responsive to the user input, the state of charge, and/or the charger information. As described above, the operation may be a reservation operation, a request operation, a command, a targeting operation or the like.

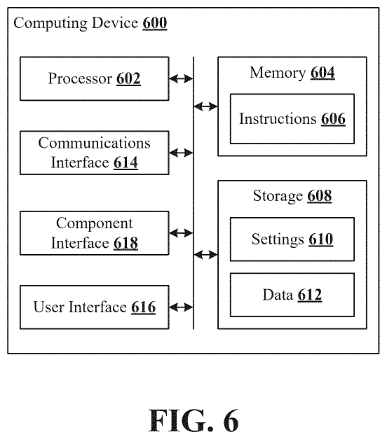

Turning to FIG. 6, illustrated is a schematic block diagram of an exemplary, non-limiting implementation for the computing device 600. Computing device 600 may be utilized to implement system 110, computing device 200, display 112, controller 114, remote system 430, or other controllers of electric machine 110. Computing device 600 includes a processor 602 configured to execute computer-executable instructions 606 such as instructions composing charging application 206. Such computer-executable instructions 606 can be stored on one or more computer-readable media including non-transitory, computer-readable storage media such as memory 604. Memory 604 can also include other data (working data or variables) or portions thereof during execution of instructions 606 by processor 602.

The computing device 600 can also include storage 608 that can be, according to an embodiment, non-volatile storage to persistently store instructions 606, settings 610 and/or data 612.

The computing device 600 may also include a user interface 616 that comprises various elements to obtain user input and to convey user output. For instance, user interface 616 can comprise of a touch display, which operates as both an input device and an output device. User interface 616 may display or output user interface 300. In addition, user interface 616 can also include various buttons, switches, keys, etc. by which a user can input information to computing device 600; and other displays, LED indicators, etc. by which other information can be output to the user. Further still, user interface 616 can include input devices such as keyboards, pointing devices, and standalone displays.

The computing device 600 further includes a communications interface 614 to couple computing device 600, via a communications network, to various devices such as, but not limited to, other computing devices 600, chargers 120 and 130, remote system 430, other controllers, servers, or Internet-enabled devices (e.g., IoT devices). Communication interface 614 can be a wired or wireless interface including, but not limited to, a WiFi interface, an Ethernet interface, a Bluetooth interface, a fiber optic interface, a cellular radio interface, a satellite interface, etc.

A component interface 618 is also provided to couple computing device 600 to various components. Component interface 618 can include a plurality of electrical connections on a circuit board or internal bus of computing device 600 that is further coupled to processor 602, memory 604, etc. Component interface 618, in another embodiment, can be an interface for a CAN bus of electric machine 120. Further, the component interface 618 can implement various wired or wireless interfaces such as, but not limited to, a USB interface, a serial interface, a WiFi interface, a short-range RF interface (Bluetooth), an infrared interface, a near-field communication (NFC) interface, etc. In an implementation, component interface 618 may be utilized to poll a battery to acquire battery information (e.g. state of charge).

According to an aspect, an electric machine is provided. The electric machine includes a battery assembly, an operator interface, and a controller that receives input data indicative of a battery assembly state and charger information. The controller includes at least one processor and a memory that stores instructions that, when executed by the at least one processor, configure the at least one processor to: generate display information based on the battery assembly state and charger information; output the display information on the operator interface, wherein the operator interface displays a user interface having a first portion providing area information; receive a user input via the operator interface, wherein the user input is indicative of a selection of an object in an area corresponding to the area information; and execute an operation based on the user input, wherein the operation relates to charging of the battery assembly.

In an example, the area information is a map of the area. The map depicts the electric machine and one or more other objects in the area. The one or more objects include one or more of a machine, another electric machine, a stationary charger, or a mobile charger.

In another example, the selection of the object initiates a reservation operation, wherein the object is reserved for use by the electric machine. In another example, the selection of the object initiates a targeting operation. Further to this example, for the targeting operation, the at least one processor is further configured to: determine a state of charge associated with the battery assembly; and determine a time-to-travel between the object and the electric machine. Moreover, the at least one processor is further configured to at least one of: alert an operator to commence travel to the object based on the state of charge and the time-to-travel; or communicate a request to the target to commence travel to the electric machine. Still further, the at least one processor is further configured to control preconditioning of the battery assembly for charging.

In yet another example, upon selection of the object, the at least one processor is further configured to: acquire object information associated with the object selected; and output the object information to the operator interface. The object information indicates one or more of a charge capacity of the object, an availability status, or type information.

In another example, a second portion of the user interface provides a battery monitor. In yet another example, the at least one processor is further configured to: determine a machine operation being performed by the electric machine; determine operational characteristics of the electric machine performing the machine operation; and predict an estimated time of battery power based on the machine operation and the operational characteristics. The at least one processor is further configured to one or more of: autonomously initiate power saving adaptations; or determine recommended actions and notify an operator.

In another aspect, a system for managing charging of electric machines is provided. The system includes an electric machine and a charger. The electric machine includes a display assembly. The display assembly includes a display screen with a touch interface, a memory, and a processor coupled to the memory. The processor is configured to: receive charger information, the charger information including at least a location, a capacity, and an availability of the charger; output a touch-enabled user interface to the display screen, the user interface including a map of an environment in which the electric machine is deployed, the map indicating at least a location of the electric machine and a location of the charger; receive a user input via the display screen indicative of a selection of the charger; and initiate automatic procedures related to charging in response to the selection of the charger.

In an example, the processor is further configured to: monitor a relative distance between the charger and the electric machine; monitor a state of charge of a battery of the electric machine; determine a time-to-travel between the electric machine and the charger; and determine when the state of charge corresponds to a level based on the time-to-travel. In this example, the processor is further configured to alert an operator of the electric machine to travel to the charger. The processor is further configured to precondition the battery of the electric machine during travel to the charger. The processor is further configured to communicate a request for the charger to travel to the electric machine.

In another example, the system includes a remote computing device communicatively coupled to the charger and the electric machine. The remote computing device includes a processor coupled to a memory and configured to: receive input indicative of a presence of the charger in the environment; obtain the charger information from the charger responsive to the input; and communicate the charger information to the electric machine.

According to yet another aspect, a method for managing charging on-board an electric machine is provided. The method includes receiving a state of charge of the electric machine. The method also includes receiving charger information respectively associated with one or more chargers deployed in an area. The method also includes displaying a user interface on an operator display of the electric machine. The user interface includes a first portion providing information related to the state of charge and a second portion providing a map of the area. The map indicates the electric machine and the one or more chargers. In addition, the method includes receiving, via the operator display, user input indicative of a selection of a charger from the one or more chargers displayed on the map. Still further, the method includes, responsive to the selection of the charger, autonomously carrying out a charging-related operation based on charger information associated with the charger selected and the state of charge of the electric machine.

The foregoing description and examples has been set forth merely to illustrate the disclosure and are not intended as being limiting. Each of the disclosed aspects and embodiments of the present disclosure may be considered individually or in combination with other aspects, embodiments, and variations of the disclosure. In addition, unless otherwise specified, none of the steps of the methods of the present disclosure are confined to any particular order of performance. Modifications of the disclosed embodiments incorporating the spirit and substance of the disclosure may occur to persons skilled in the art and such modifications are within the scope of the present disclosure. Furthermore, all references cited herein are incorporated by reference in their entirety.

Conditional language used herein, such as, among others, “can,” “might,” “may,” “e.g.,” and the like, unless specifically stated otherwise, or otherwise understood within the context as used, is generally intended to convey that some embodiments include, while other embodiments do not include, certain features, elements, and/or states. Thus, such conditional language is not generally intended to imply that features, elements, blocks, and/or states are in any way required for one or more embodiments or that one or more embodiments necessarily include logic for deciding, with or without author input or prompting, whether these features, elements and/or states are included or are to be performed in any particular embodiment.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

The terms “approximately,” “about,” and “substantially” as used herein represent an amount close to the stated amount that still performs a desired function or achieves a desired result. For example, in some embodiments, as the context may dictate, the terms “approximately”, “about”, and “substantially” may refer to an amount that is within less than or equal to 10% of the stated amount. The term “generally” as used herein represents a value, amount, or characteristic that predominantly includes or tends toward a particular value, amount, or characteristic. As an example, in certain embodiments, as the context may dictate, the term “generally parallel” can refer to something that departs from exactly parallel by less than or equal to 20 degrees.

Unless otherwise explicitly stated, articles such as “a” or “an” should generally be interpreted to include one or more described items. Accordingly, phrases such as “a device configured to” are intended to include one or more recited devices. Such one or more recited devices can be collectively configured to carry out the stated recitations. For example, “a processor configured to carry out recitations A, B, and C” can include a first processor configured to carry out recitation A working in conjunction with a second processor configured to carry out recitations B and C.

The terms “comprising,” “including,” “having,” and the like are synonymous and are used inclusively, in an open-ended fashion, and do not exclude additional elements, features, acts, operations, and so forth. Likewise, the terms “some,” “certain,” and the like are synonymous and are used in an open-ended fashion. Also, the term “or” is used in its inclusive sense (and not in its exclusive sense) so that when used, for example, to connect a list of elements, the term “or” means one, some, or all of the elements in the list.

Overall, the language of the claims is to be interpreted broadly based on the language employed in the claims. The language of the claims is not to be limited to the non-exclusive embodiments and examples that are illustrated and described in this disclosure, or that are discussed during the prosecution of the application.

Certain features that are described in this disclosure in the context of separate implementations can be implemented in combination in a single implementation. Conversely, various features that are described in the context of a single implementation can be implemented in multiple implementations separately or in any suitable subcombination. Although features may be described herein as acting in certain combinations, one or more features from a claimed combination can, in some cases, be excised from the combination, and the combination may be claimed as any subcombination or variation of any subcombination.

While the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various embodiments described and the appended claims. Further, the disclosure herein of any particular feature, aspect, method, property, characteristic, quality, attribute, element, or the like in connection with an embodiment can be used in all other embodiments set forth herein. Any methods disclosed herein need not be performed in the order recited. Depending on the embodiment, one or more acts, events, or functions of any of the algorithms, methods, or processes described herein can be performed in a different sequence, can be added, merged, or left out altogether (e.g., not all described acts or events are necessary for the practice of the algorithm). In some embodiments, acts or events can be performed concurrently, e.g., through multi-threaded processing, interrupt processing, or multiple processors or processor cores or on other parallel architectures, rather than sequentially. Further, no element, feature, block, or step, or group of elements, features, blocks, or steps, are necessary or indispensable to each embodiment. Additionally, all possible combinations, subcombinations, and rearrangements of systems, methods, features, elements, modules, blocks, and so forth are within the scope of this disclosure. The use of sequential, or time-ordered language, such as “then,” “next,” “after,” “subsequently,” and the like, unless specifically stated otherwise, or otherwise understood within the context as used, is generally intended to facilitate the flow of the text and is not intended to limit the sequence of operations performed. Thus, some embodiments may be performed using the sequence of operations described herein, while other embodiments may be performed following a different sequence of operations.

Moreover, while operations may be depicted in the drawings or described in the specification in a particular order, such operations need not be performed in the particular order shown or in sequential order, and all operations need not be performed, to achieve the desirable results. Other operations that are not depicted or described can be incorporated in the example methods and processes. For example, one or more additional operations can be performed before, after, simultaneously, or between any of the described operations. Further, the operations may be rearranged or reordered in other implementations. Also, the separation of various system components in the implementations described herein should not be understood as requiring such separation in all implementations, and it should be understood that the described components and systems can generally be integrated together in a single product or packaged into multiple products. Additionally, other implementations are within the scope of this disclosure.

Some embodiments have been described in connection with the accompanying figures. Certain figures are drawn and/or shown to scale, but such scale should not be limiting, since dimensions and proportions other than what are shown are contemplated and are within the scope of the embodiments disclosed herein. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various embodiments can be used in all other embodiments set forth herein. Additionally, any methods described herein may be practiced using any device suitable for performing the recited steps.

The methods disclosed herein may include certain actions taken by a practitioner; however, the methods can also include any third-party instruction of those actions, either expressly or by implication.

In summary, various embodiments and examples of systems and methods for charging management have been disclosed. Although the systems and methods for charging management have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Thus, the scope of this disclosure should not be limited by the particular disclosed embodiments described herein, but should be determined only by a fair reading of the claims that follow.

1. An electric machine, comprising:
a battery assembly;
an operator interface; and
a controller that receives input data indicative of a battery assembly state and charger information, wherein the controller includes:
at least one processor; and
a memory that stores instructions that, when executed by the at least one processor, configure the at least one processor to:
generate display information based on the battery assembly state and charger information;
output the display information on the operator interface, wherein the operator interface displays a user interface having a first portion providing area information;
receive a user input via the operator interface, wherein the user input is indicative of a selection of an object in an area corresponding to the area information; and
execute an operation based on the user input, wherein the operation relates to charging of the battery assembly.

2. The electric machine of claim 1, wherein the area information is a map of the area.

3. The electric machine of claim 2, wherein the map depicts the electric machine and one or more other objects in the area.

4. The electric machine of claim 3, wherein the one or more objects include one or more of a machine, another electric machine, a stationary charger, or a mobile charger.

5. The electric machine of claim 1, wherein the selection of the object initiates a reservation operation, wherein the object is reserved for use by the electric machine.

6. The electric machine of claim 1, wherein the selection of the object initiates a targeting operation.

7. The electric machine of claim 6, wherein, for the targeting operation, the at least one processor is further configured to:
determine a state of charge associated with the battery assembly; and
determine a time-to-travel between the object and the electric machine.

8. The electric machine of claim 7, wherein the at least one processor is further configured to at least one of:
alert an operator to commence travel to the object based on the state of charge and the time-to-travel; or
communicate a request to the target to commence travel to the electric machine.

9. The electric machine of claim 7, wherein the at least one processor is further configured to control preconditioning of the battery assembly for charging.

10. The electric machine of claim 1, wherein, upon selection of the object, the at least one processor is further configured to:
acquire object information associated with the object selected; and
output the object information to the operator interface,
wherein the object information indicates one or more of a charge capacity of the object, an availability status, or type information.

11. The electric machine of claim 1, wherein a second portion of the user interface provides a battery monitor.

12. The electric machine of claim 1, wherein the at least one processor is further configured to:
determine a machine operation being performed by the electric machine;
determine operational characteristics of the electric machine performing the machine operation; and
predict an estimated time of battery power based on the machine operation and the operational characteristics.

13. The electric machine of claim 12, wherein the at least one processor is further configured to one or more of:
autonomously initiate power saving adaptations; or
determine recommended actions and notify an operator.

14. A system for managing charging of electric machines, comprising:
an electric machine; and
a charger,
wherein the electric machine includes a display assembly, the display assembly having a display screen with a touch interface, a memory, and a processor coupled to the memory, the processor being configured to:
receive charger information, the charger information including at least a location, a capacity, and an availability of the charger;
output a touch-enabled user interface to the display screen, the user interface including a map of an environment in which the electric machine is deployed, the map indicating at least a location of the electric machine and a location of the charger;
receive a user input via the display screen indicative of a selection of the charger; and
initiate automatic procedures related to charging in response to the selection of the charger.

15. The system of claim 14, wherein the processor is further configured to:
monitor a relative distance between the charger and the electric machine;
monitor a state of charge of a battery of the electric machine;
determine a time-to-travel between the electric machine and the charger; and
determine when the state of charge corresponds to a level based on the time-to-travel.

16. The system of claim 15, wherein the processor is further configured to alert an operator of the electric machine to travel to the charger.

17. The system of claim 16, wherein the processor is further configured to precondition the battery of the electric machine during travel to the charger.

18. The system of claim 15, wherein the processor is further configured to communicate a request for the charger to travel to the electric machine.

19. The system of claim 14, further comprising a remote computing device communicatively coupled to the charger and the electric machine, the remote computing device having a processor coupled to a memory and configured to:
receive input indicative of a presence of the charger in the environment;
obtain the charger information from the charger responsive to the input; and
communicate the charger information to the electric machine.

20. A method for managing charging on-board an electric machine, comprising:
receiving a state of charge of the electric machine;
receiving charger information respectively associated with one or more chargers deployed in an area;
displaying a user interface on an operator display of the electric machine, the user interface having a first portion providing information related to the state of charge and a second portion providing a map of the area, the map indicating the electric machine and the one or more chargers;
receiving, via the operator display, user input indicative of a selection of a charger from the one or more chargers displayed on the map; and
responsive to the selection of the charger, autonomously carrying out a charging-related operation based on charger information associated with the charger selected and the state of charge of the electric machine.
